(19) United States
(12) Patent Application Publication
(10) Pub. No.: US 2009/0273581 A1
(43) Pub. Date: Nov. 5, 2009

(54) DISPLAY FILTER AND DISPLAY DEVICE HAVING THE SAME

(75) Inventors: Shin Wook Kim, ChungCheongNam-Do (KR); Dae Chul Park, ChungCheongNam-Do (KR); Gi Mo Yang, ChungCheongNam-Do (KR); Dong Keun Shin, ChungCheongNam-Do (KR); Sang Yoon Oh, ChungCheongNam-Do (KR); Hwa Yeon Lee, ChungCheongNam-Do (KR); Cheol Hee Park, ChungCheongNam-Do (KR)

Correspondence Address: MCDERMOTT WILL & EMERY LLP, 600 13TH STREET, N.W., WASHINGTON, DC, 20005-3096, US

(73) Assignee: SAMSUNG CORNING PRECISION GLASS CO., LTD.

(21) Appl. No.: 12/431,425

(22) Filed: Apr. 28, 2009

(30) Foreign Application Priority Data
Apr. 30, 2008 (KR) 10-2008-0040308
Feb. 6, 2009 (KR) 10-2009-0009586

(51) Int. Cl. G06F 3/042

(52) U.S. Cl. 345/175

(57) ABSTRACT

A display filter for a display device having a display panel includes a base substrate disposed in front of the display panel; an optical filter part layered based on the base substrate and comprising at least an anti-reflection layer; and a touch signal sensing part layered on the base substrate or the optical filter part and sensing a touch signal by a sensed object. An optical filter and a touch input means are combined together, and thereby the display filter can perform a touch input function as well as an optical filter function.

### CROSS-REFERENCE TO RELATED APPLICATION

This application claims the benefit of Korean Patent Application Nos. 2009-0009586 filed on Feb. 6, 2009 and 2008-0040308 filed on Apr. 30, 2008 in the Korean Intellectual Property Office, the disclosure of which is incorporated herein by reference.

### BACKGROUND OF THE INVENTION

1. Field of the Invention

The present invention relates to a display filter and a display device having the same, more particularly, to a display filter and a display device integrally having a touch signal sensing part which makes it possible to input information by touch.

2. Description of the Related Art

Display devices develop as the society becomes information-oriented. Recently, a variety of display devices such as an LCD (Liquid Crystal Display) device, a PDP (Plasma Display Panel) device, an ELD (Electro Luminescent Display) device, a VFD (Vacuum Fluorescent Display) device, etc was developed. Some of them are being used as a display device for various apparatuses.

As one example of display devices, an LCD device is manufactured by fabricating a TFT array substrate and a color filter substrate through a TFT array substrate fabrication process in which a thin film transistor and a pixel electrode are fabricated and through a color filter substrate fabrication process in which a color filter and a common electrode are fabricated, respectively and providing liquid crystal between the TFT array substrate and the color filter substrate through a liquid crystal cell process.

As another example of display devices, a PDP device generates discharge in the gas between electrodes by supplying direct current or alternating current to the electrodes to create ultraviolet rays. The ultraviolet rays activate a fluorescent material to emit visible light.

The PDP device has a drawbacks that a large amount of electromagnetic waves and near infrared rays are emitted, the fluorescent material causes high reflection and color purity is bad due to orange light emitted from He or Xe. Accordingly, the PDP device can have bad effects on a human body due to the electromagnetic waves and near infrared rays and cause malfunction of a precise appliance such as a mobile phone or a remote controller.

Accordingly, it is required to lower the amount of the electromagnetic waves and near infrared rays emitted form the PDP device to be under a prescribed value. For this reason, the PDP device employs a filter which can perform function of blocking the electromagnetic and near infrared rays, reducing the reflection, and improving the color purity.

The current trend is towards increasing the size of display devices and the use of outdoor display devices for advertising or providing information.

In the past, display devices were used to provide one-way information. However, nowadays, users can have interactive communication using an input device by which the users can directly input information with the help of display devices. For example, users can input information by using a remote controller, while watching display devices. As another example, users can input information by directly touching a screen of a touch input device which is placed in the front of display devices.

In a conventional art, a touch input device is provided independently of a display device and therefore has to be installed in the display device. Accordingly, the sensibility of the touch input device deteriorates, the thickness of the display device increases, and the touch input device tends to separate from the display device as the time goes by.

When an LCD device is used outdoors, the temperature in the display device increases due to solar light, and the phase transition of liquid crystal can occur.

Nowadays, the current trend is towards employing a protective glass to protect the display module in an LCD monitor/TV. However, the protective glass causes condensation in the LCD monitor/TV due to the temperature difference between the inside and the outside thereof. Generally, in a PDP device, the condensation can be easily and quickly removed because the PDP panel emits heat immediately after the power is On. However, in an LCD device, it is difficult to remove the condensation because the LCD panel emits only a small amount of heat.

### SUMMARY OF THE INVENTION

The present invention has been made to solve the foregoing problems. An object of the present invention is to provide a display filter which can function as an optical filter and at the same time perform information input function by incorporating a touch input means into the display filter.

Another object of the present invention is to provide a display filter the thickness of which can be minimized.

Still another object of the present invention is to provide a display filter which has an anti-fog function.

Still another object of the present invention is to provide a display filter which can block external noise causing malfunctions of outdoor display devices.

The present invention is characterized in that a touch input means for inputting information by touching a surface of the display device is incorporated into a display filter disposed in front of the display panel for displaying images. The present invention provides a display filter for a display device having a display panel, the display filter including a base substrate disposed in front of the display panel; an optical filter part layered based on the base substrate and including at least an anti-reflection layer; and a touch signal sensing part layered on the base substrate or the optical filter part and sensing a touch signal by a sensed object so that the display filter can perform a touch input function.

In case that the display filter has a touch input function of a resistive type, the touch signal sensing part includes a first touch sheet in which a first electrode layer is formed on a front surface of the base substrate, and a second touch sheet disposed such that an air gap is formed between the first touch sheet and the second touch sheet, wherein a second electrode layer is formed on a transparent film and can come into contact with the first electrode layer by an external touch force.

In case that the display filter has a touch input function of a capacitive type, the touch signal sensing part includes a transparent electrode layer which is layered in the rear of the base substrate, and transmits electricity due to capacitance at a touched location when the sensed object touches the display filter, and a controller which determines the touched location using the electricity transmitted from the transparent electrode layer.

Preferably, the display filter can further include an anti-fog layer which prevents the display filter from becoming fogged due to the moisture in a space between the display filter and the display panel.

The present invention can provide a display filter which can function as an optical filter and at the same time perform an information input function by incorporating a touch input means into the display filter.

In the present invention, a base substrate supporting each layer of an optical filter part also supports a touch signal sensing part, which makes it possible to minimize the thickness of the display filter.

In the present invention, an anti-fog layer is formed in front of a display panel, which makes it possible to prevent a surface of the display filter facing the display panel from becoming fogged.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 to 11 are cross sectional views illustrating display filters according to first to eleventh embodiments of the present invention.

### DETAILED DESCRIPTION OF THE EXEMPLARY EMBODIMENT

The present invention will now be described more fully hereinafter with reference to the accompanying drawings, in which exemplary embodiments thereof are shown.

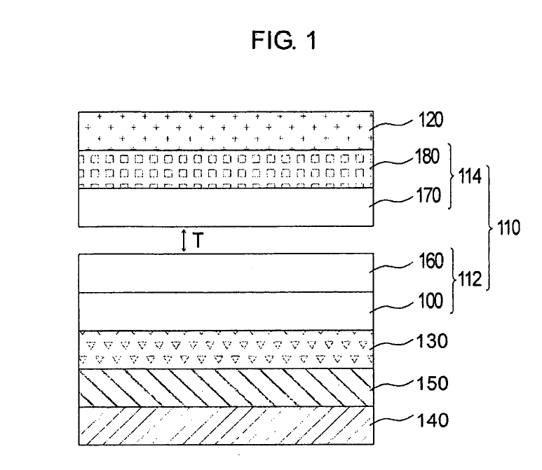

FIG. 1 is a cross sectional view illustrating a display filter according to a first embodiment of the present invention.

The display filter includes a base substrate 100, a touch signal sensing part 110 formed based on the base substrate 100, and an optical filter part including an anti-reflection layer 120 formed on the touch signal sensing part, and an electromagnetic wave blocking layer 130 and a color compensation layer 140 formed on the base substrate 100.

The base substrate 100 can be made of a transparent material. For example, the base substrate 100 can be made of heat strengthened glass. The base substrate 100 can be made of transparent polymer resin such as Poly-carbonate (PC), Poly-ethylene-terephthalate (PET), etc. It is preferable that the base substrate 100 has high transparency to visible light of 80% or more and its glass transition temperature is 50° C. or more.

The base substrate 100 can be fabricated by molding a polymer or stacking molded polymers together. For example, the base substrate 100 can be made of Poly-ethylene-terephthalate (transparent), Poly-sulfone (PS), Poly-ether-sulfone (PES), Poly-styrene, Poly-ethylene-naphthalate, Polyarylate, Poly-ether-ether-kethone (PEEK), Poly-carbonate (PC), Poly-propylene (PP), Poly-imide, Tri-acetyl-cellulose (TAC), Poly-methyl-meta-acrylate (PMMA), etc.

The base substrate 100 supports functional layers performing filtering functions such as the color compensation layer 140, the electromagnetic wave blocking layer 130, etc. and at the same time, functions as a substrate which is one of essential parts of the touch signal sensing part 110. That is, the present invention supports each layer performing filtering functions and the touch signal sensing part at the same time by using only the single base substrate 100, which makes it possible to reduce the thickness of the display filter and the fabrication cost.

As shown in the figure, the touch signal sensing part 110 in FIG. 1 is a resistive type. That is, the touch signal sensing part of a resistive type includes a first touch sheet 112 and a second touch sheet 114. In the first touch sheet 112, a first electrode layer 160 is formed on the base substrate 100. The second touch sheet 114 is disposed in front of the first touch sheet 112 such that an air gap is formed between the first touch sheet 112 and the second touch sheet 114. The second touch sheet 114 includes a transparent film 180 and a second electrode layer 170 formed on the transparent film 180.

It is preferable that the transparent film 180 is made of elastic resin which can return to its original shape after a pressing stops. More preferably, the transparent film 180 can be made of PET. The base substrate 100 is made of rigid material. Accordingly, the base substrate 100 can function as a supporter which endures an external force applied when the second touch sheet 114 is pressed.

The first electrode layer 160 and second electrode layer 170 can be made of any conductive material as long as the conductive material allows the detection of the voltage at a location where the two electrode layers comes into contact with each other. Especially, the electrode layers can be made of a transparent conductive material such as ITO. An existing ITO glass can be used as the first touch sheet 112. An existing ITO film can be used as the second touch sheet 114.

The first electrode layer 160 and second electrode layer 170 are disposed facing each other in such a manner that a predetermined air gap is interposed between the two electrode layers. When the second touch sheet 114 is pressed, it comes into contact with the first touch sheet 112. Then, the voltage at a location where the two electrode layers comes into contact with each other is detected, by which the location can be determined.

A plurality of spacers can be interposed between the first touch sheet 112 and the second touch sheet 114 to maintain the gap therebetween.

The anti-reflection layer 120 is formed on the transparent film 180. The anti-reflection layer 120 is formed in the forefront facing a viewer. The anti-reflection layer 120 minimizes the reflection of external light incident onto the display filter, and thereby prevents display quality from deteriorating due to the reflection.

The anti-reflection layer 120 can be replaced by a hard-coating layer which protects the display filter from an external impact or a hard-coating layer can be layered on one surface of the anti-reflection layer 120. A near infrared ray blocking layer and a neon-light blocking layer can be layered together with the anti-reflection layer 120.

The electromagnetic wave blocking layer 130 is formed on the rear surface of the base substrate 100 to block electromagnetic waves. The electromagnetic wave blocking layer 130 can be a conductive mesh film or a multi-layered transparent conductive film in which a metal thin film and a high refractive transparent thin film are layered together.

The conductive mesh film can include a metal mesh, a metal coated synthetic resin mesh or a metal coated metal fiber mesh which is grounded. Here, the mesh can be made of any metal, for example, copper, chrome, nickel, silver, molybdenum, tungsten, aluminum, etc, as long as the metal has good conductivity and workability.

The multi-layered transparent conductive film can include the high refractive transparent thin film such as an ITO thin film. In the multi-layered transparent conductive film, the metal thin film of gold, silver, copper, platinum, palladium, etc and the high refractive transparent thin film of indium oxide, stannic oxide, zinc oxide, etc are alternately layered.

The metal thin film can be made of silver or silver alloy. Especially, silver is generally used because it has high conductivity, high infrared reflectivity, and high transparency to visible light. However, pure silver has low chemical stability and can easily deteriorate under the influence of the ambient condition such as a pollutant, a vapor, heat, light, etc. Accordingly, it is preferable that the metal thin film can be made of an alloy of silver and at least one of gold, platinum, palladium, copper, indium, tin, etc.

When the multi-layered transparent conductive film is used, it is possible to prevent the phase transition of liquid crystal which occurs due to the increase in temperature inside of an outdoor display device by solar light.

The color compensation layer 140 is adhered to the back surface of the electromagnetic wave blocking layer 130 by means of an adhesive layer 150. The color compensation layer 140 reduces or adjusts the amount of red, green, or blue to change or adjust color balance.

In the PDP panel, red visible light tends to change into orange. The color compensation layer 140 can absorb an orange wavelength range to make the discolored visible light return to red.

The color compensation layer 140 can use various colorants to improve a color reproduction range and image quality. The color compensation layer 140 can include an organic colorant to block a neon light, for example, an anthraquinone type colorant, an azo type colorant, a stryl type colorant, a phthalocyanine type colorant, a methine type colorant, etc. The kind and concentration of the colorant is determined based on an absorption wavelength, an absorption coefficient, a light transmission property required in the display device, and thus is not limited to a particular value.

The adhesive layer 150 can be used to adhere the above-mentioned functional layers together. Examples of the adhesive layer 150 are an acryl type adhesive layer, a silicone type adhesive layer, a urethane type adhesive layer, a polyvinylbutyral (PMB) adhesive layer, an ethylene-vinyl acetate (EVA) adhesive layer, a poly vinyl ether adhesive layer, a saturated amorphous poly ester adhesive layer, a melamine adhesive layer, etc.

The adhesive layer 150 is interposed between the electromagnetic wave blocking layer 130 and the color compensation layer 140 in FIG. 1. However, such an adhesive layer can also be provided between other layers.

The display filter according to the present invention can include a variety of other functional layers. The figures exemplify several stacking orders of the component layers, but the present invention is not limited thereto. The present invention can have a variety of other stacking orders.

The display filter integrally have the touch signal sensing part of a resistive type, and thus can perform a filter function and can perform a information input function at the same time. The base substrate 100 which is a component part of the optical filter part also functions as a supporter of the touch signal sensing part. Accordingly, each component layer of the optical filter part and the touch signal sensing part can be supported by only the single base substrate 100, which makes it possible to reduce the thickness of the display device.

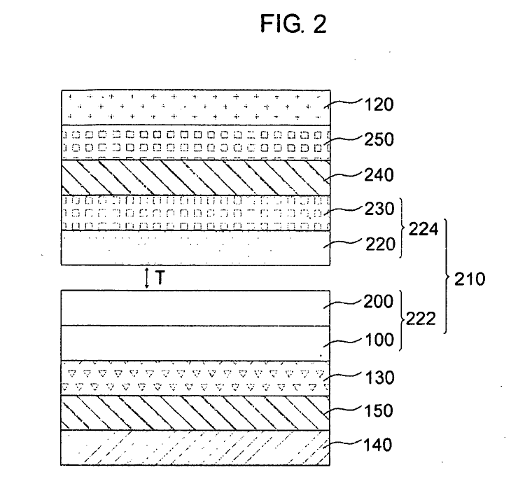

FIG. 2 is a cross sectional view illustrating a display filter according to a second embodiment of the present invention.

The display filter includes a base substrate 100, a touch signal sensing part 210 formed based on the base substrate, and an optical filter part including an anti-reflection layer 120 formed on the touch signal sensing part, and an electromagnetic wave blocking layer 130 and a color compensation layer 140 formed on the base substrate.

The base substrate 100 has such a structure as is described in the first embodiment. The base substrate supports layer of the optical filter part and at the same time functions as a supporter of the touch signal sensing part 210.

The touch signal sensing part 210 includes a first touch sheet 222 and a second touch sheet 224. In the first touch sheet, an electrode layer 200 is formed on the base substrate 100. The second touch sheet is disposed in front of the first touch sheet such that an air gap is formed between the first touch sheet and the second touch sheet. The second touch sheet includes a transparent film 230 and a conductive mesh pattern 220 formed on the transparent film 230.

The conductive mesh pattern can also be formed on both of the base substrate 100 and the transparent film. The conductive mesh pattern can also be formed on either of the base substrate 100 and the transparent film 230.

An anti-reflection layer 120 is formed on another surface of the transparent film 230. As shown in the figure, the anti-reflection layer 120 can be formed on another transparent film 250 which is adhered to the transparent film 230 of the second touch sheet 224 by means of an adhesive layer 240.

Alternatively, the anti-reflection layer 120 can be directly coated onto the transparent film 230 of the second touch sheet 224, as described in the first embodiment.

The anti-reflection layer 120 is similar to that of the first embodiment. The anti-reflection layer can be replaced by a hard coating layer or a hard coating layer can be formed on one surface of the anti-reflection layer 120.

The electromagnetic wave blocking layer 130 is formed on another surface of the base substrate 100. The color compensation layer 140 is formed on the electromagnetic wave blocking layer 130.

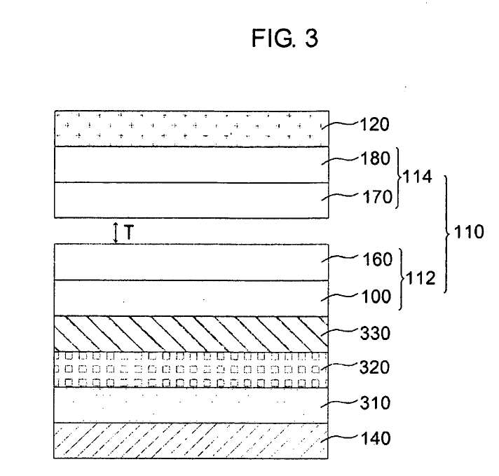

FIG. 3 is a cross sectional view illustrating a display filter according to a third embodiment of the present invention.

The display filter of this embodiment has such a structure as is described in the first embodiment except that a conductive mesh 310 is formed on a transparent film 320 in an electromagnetic wave blocking layer according to this embodiment. The transparent film 320 is adhered to a base substrate 100 by means of an adhesive layer 330.

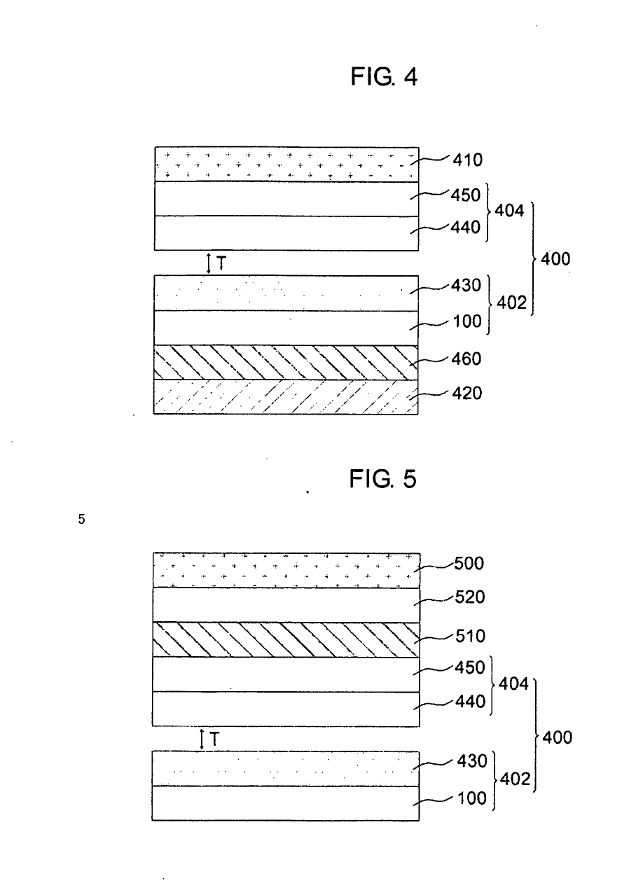

FIG. 4 is a cross sectional view illustrating a display filter according to a fourth embodiment of the present invention.

The display filter includes a base substrate 100, a touch signal sensing part 400 formed based on the base substrate and performing a touch input function, and an optical filter part including an anti-reflection layer 410 formed on the touch signal sensing part, and a color compensation layer 420 formed on the base substrate.

The touch signal sensing part 400 includes a first touch sheet 402 and a second touch sheet 404. In the first touch sheet, a conductive mesh pattern 430 is formed on the base substrate. The second touch sheet is disposed in front of the first touch sheet such that an air gap is formed between the first touch sheet and the second touch sheet. The second touch sheet includes a transparent film 450 and an electrode layer 440 formed on the transparent film 450.

The conductive mesh pattern 430 formed on the base substrate comes into contact with the electrode layer 440 which is formed on a transparent film 450 and made of a conductive material such as ITO. The conductive mesh pattern 430 and the electrode layer 440 detect a voltage in order to determine a touched location, by which the display filter can perform a touch input function.

The conductive mesh pattern 430 can be made of a high conductive material such as copper, chrome, nickel, silver, molybdenum, tungsten, aluminum, etc. The conductive mesh pattern 430 is formed on the base substrate 100 to function as a conductor of the first touch sheet 402.

The electrode layer 440 can be replaced by another conductive mesh pattern.

The anti-reflection layer 410 and the color compensation layer 420 have such a structure as is described in the first embodiment. The color compensation layer 420 is adhered to the other surface of the base substrate 100 by means of an adhesive layer 460.

FIG. 5 is a cross sectional view illustrating a display filter according to a fifth embodiment of the present invention.

The display filter includes a base substrate 100, a touch signal sensing part 400 formed based on the base substrate and performing a touch input function, and an optical filter part including an anti-reflection layer 500 which is formed on the touch signal sensing part 400, and can perform a color compensation function.

The touch signal sensing part 400 includes such a conductive mesh pattern as is described in the fourth embodiment.

The anti-reflection layer 500 is formed on a transparent film 520 which is adhered to another transparent film 450 of the touch signal sensing part 400. The anti-reflection layer 500 has a color compensation function as well as an anti-reflection function.

The display filter in this embodiment makes it possible to reduce the number of layers, whereby the thickness of the display filter can be reduced.

The first to fifth embodiments described above relate to the PDP display filters which are provided with a touch input means of a resistive type. However, such a structure can be applied to not only a PDP display device but also other display devices.

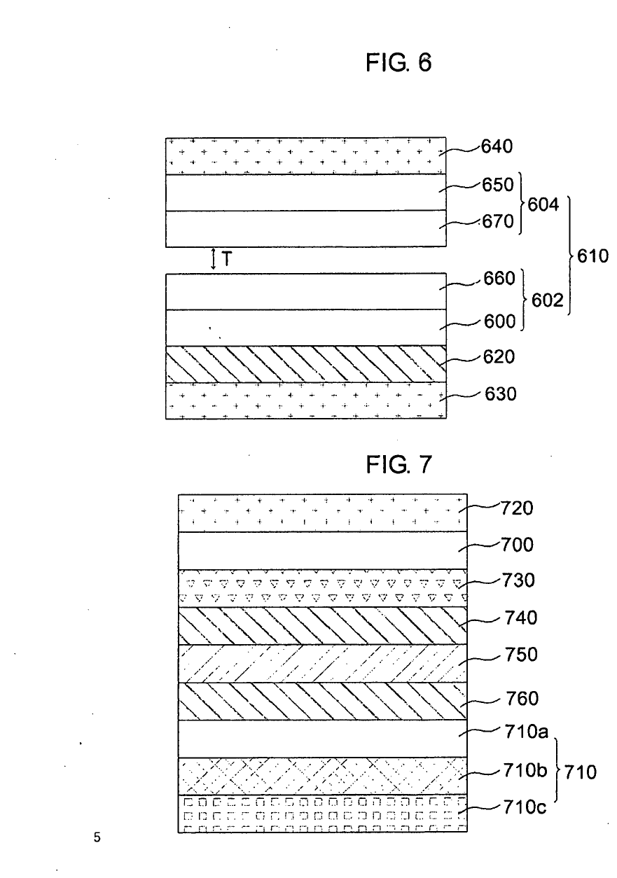

FIG. 6 is a cross sectional view illustrating a display filter according to sixth embodiment of the present invention.

In this embodiment, a touch signal sensing part of a resistive type is incorporated into the LCD display filter. However, this structure can also be applied to other display devices than an LCD device.

The display filter includes a base substrate 600, a touch signal sensing part 610 formed based on the base substrate and performing a touch input function, and an optical filter part including a first anti-reflection layer 640 which is formed on the touch signal sensing part, and a second anti-reflection layer 630 which is formed on the base substrate.

The touch signal sensing part 610 includes a first touch sheet 602 and a second touch sheet 604. In the first touch sheet, a first electrode layer 660 is formed on the base substrate. The second touch sheet is disposed in front of the first touch sheet such that an air gap is formed between the first touch sheet and the second touch sheet. The second touch sheet includes a transparent film 650 and a second electrode layer 670 formed on the transparent film 650.

The touch signal sensing part in FIG. 6 is the same as that in FIG. 1 but the present invention is not limited thereto. For example, the touch signal sensing parts in FIG. 2 to 5 can also be used in this embodiment.

A reference numeral 630 denotes the second anti-reflection layer adhered to the base substrate by means of an adhesive layer 620. However, according to another embodiment, the second anti-reflection layer 630 can be replaced by an anti-fog layer.

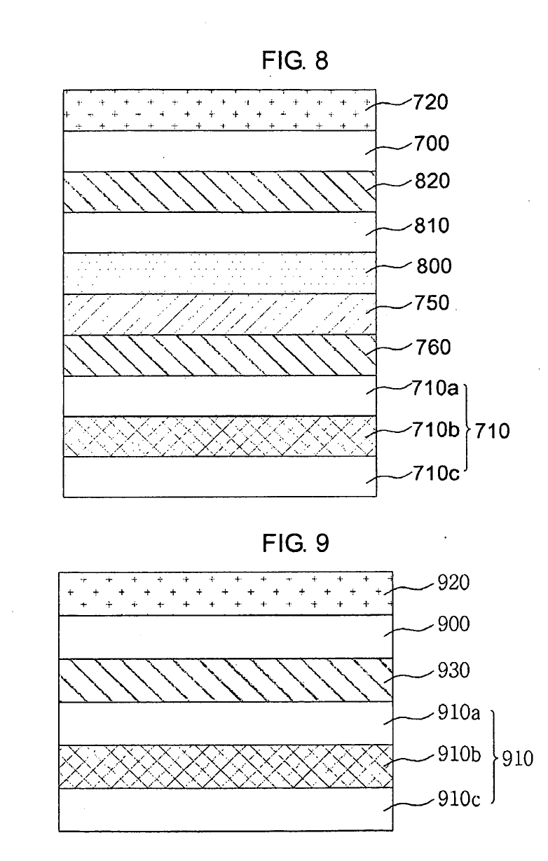

FIGS. 7 and 8 are cross sectional view illustrating display filters according to seventh and eighth embodiments of the present invention.

In FIGS. 7 and 8, a touch signal sensing part of a capacitive type is incorporated into the PDP display filter.

The display filter includes a base substrate 700, an optical filter part including an anti-reflection layer 720 formed on one surface of the base substrate, an electromagnetic wave blocking layer 730 formed on the other surface of the base substrate, and a color compensation layer 750 formed on the electromagnetic wave blocking layer and the touch signal sensing part 710 of a capacitive type formed on the color compensation layer.

The base substrate 700, the anti-reflection layer 720, the electromagnetic wave blocking layer 730 and the color compensation layer 750 have a similar structure and function to those in the embodiments above. Accordingly, the description thereof will be omitted.

The touch signal sensing part is layered on the back of an adhesive layer 760. The touch signal sensing part includes a transparent electrode layer 710b and first and second transparent films 710a, 710c formed on both surfaces of the transparent electrode layer 710b. When a sensed object, for example, part of a human body such as a finger is touched with a surface of the display filter, capacitance is created at a touched location. The transparent electrode layer 710b transmits a small amount of electricity due to the capacitance. It is preferable that the first and second transparent films 710a, 710c are made of PET.

Although not shown, the touch signal sensing part can include a controller. The controller determines the touched location using the electricity transmitted from the transparent electrode layer. For example, the controller can include a resistance unit for detecting current, a current-to-voltage converting circuit for converting a detected current to a voltage, an amplifier circuit, a noise reduction circuit, a filtering circuit, an analog-to-digital converter and a microprocessor.

Since the touch signal sensing part of a capacitive type can be fabricated using only the single electrode layer 710b, it is possible reduce the thickness and obtain high transparency. In addition, since an air gap is not necessary, it is possible to reduce reflection.

Adhesive layers can be inserted between layers, whereby the layers can be adhered to each other.

The electromagnetic wave blocking layer 730 can be a transparent conductive film as shown in FIG. 7 or a conductive mesh film as shown in FIG. 8. The transparent conductive film and the conductive mesh film have such a structure as described in the above-mentioned embodiments.

As shown in FIG. 8, in the conductive mesh film, a conductive mesh 800 is formed on a transparent film 810 which is adhered to the base substrate 700 by means of an adhesive layer 820.

FIG. 9 is a cross sectional view illustrating a display filter according to a ninth embodiment of the present invention.

In the display filter according to the ninth embodiment, a touch signal sensing part 910 of a capacitive type is incorporated into the display filter for an LCD device.

That is, the display filter includes a base substrate 900, an anti-reflection layer 920 formed on one surface of the base substrate, and the touch signal sensing part 910 adhered to the other surface of the base substrate by means of an adhesive layer 930.

The touch signal sensing part 910 includes a transparent electrode layer 910b and first and second transparent films 910a, 910c formed on both surfaces of the transparent electrode layer. When part of a human body such as a finger is touched with a surface of the display filter, capacitance is created at a touched location. The transparent electrode layer transmits a small amount of electricity due to the capacitance. It is preferable that the first and second transparent films are made of PET.

Although not shown, the touch signal sensing part can include a controller. The controller determines the touched location using the electricity transmitted from the transparent electrode layer. For example, the controller can include a resistance unit for detecting current, a current-to-voltage converting circuit for converting a detected current to a voltage, an amplifier circuit, a noise reduction circuit, a filtering circuit, an analog-to-digital converter and a microprocessor.

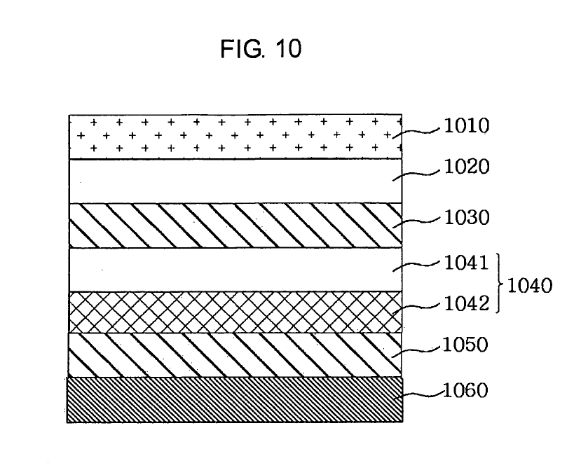

FIG. 10 is a cross sectional view illustrating a display filter according to a tenth embodiment of the present invention.

In the display filter according to this embodiment, a touch signal sensing part 1040 of a capacitive type is incorporated into the display filter for an LCD device.

As shown in the figure, the display filter includes a base substrate, an anti-reflection layer 1010, the touch signal sensing part 1040 adhered to the base substrate by means of an adhesive layer 1030 and an anti-fog layer 1060 adhered to the touch signal sensing part 1040 by means of an adhesive layer 1050.

The touch signal sensing part includes a transparent film 1041 and a transparent electrode layer 1042 formed on the transparent film 1041. When part of a human body such as a finger is touched with a surface of the display filter, capacitance is created at a touched location. The transparent electrode layer transmits a small amount of electricity due to the capacitance. It is preferable that the transparent film is made of PET.

Any electrode layer of a capacitive type can be used as the transparent electrode layer as long as it can receive and transmit an input signal.

Although not shown, the touch signal sensing part can include a controller. The controller determines the touched location using the electricity transmitted from the transparent electrode layer. For example, the controller can include a resistance unit for detecting current, a current-to-voltage converting circuit for converting a detected current to a voltage, an amplifier circuit, a noise reduction circuit, a filtering circuit, an analog-to-digital converter and a microprocessor.

The anti-fog layer 1060 prevents the display filter from becoming fogged by the moisture in the space between the display filter and the display panel. For example, the anti-fog layer can be made by applying water, poly-vinyl-pyrrolidone and a surfactant onto a polyester film to form a hydrophilic coating layer.

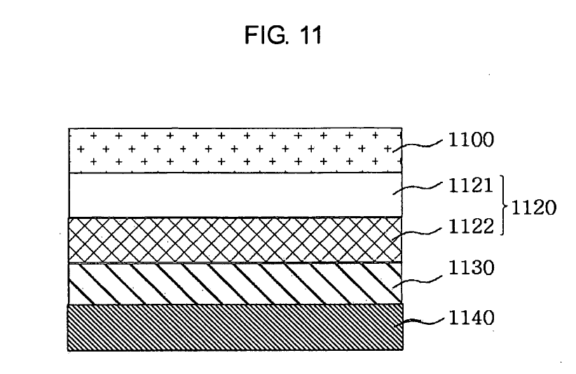

FIG. 11 is a cross sectional view illustrating a display filter according to an eleventh embodiment of the present invention.

In the display filter according to this embodiment, a touch signal sensing part 1120 of a capacitive type is incorporated into the display filter for an LCD device.

When part of a human body such as a finger is touched with a surface of the display filter, capacitance is created at a touched location. The transparent electrode layer 1122 transmits a small amount of electricity due to the capacitance.

Although not shown, the touch signal sensing part can include a controller. The controller determines the touched location using the electricity transmitted from the transparent electrode layer. For example, the controller can include a resistance unit for detecting current, a current-to-voltage converting circuit for converting a detected current to a voltage, an amplifier circuit, a noise reduction circuit, a filtering circuit, an analog-to-digital converter and a microprocessor.

The anti-fog layer 1140 prevents the display filter from becoming fogged by the moisture in the space between the display filter and the display panel. For example, the anti-fog layer can be made by applying water, poly-vinyl-pyrrolidone and a surfactant onto a polyester film to form a hydrophilic coating layer.

Hereinbefore, the present invention has exemplified the PDP filter and the PDP device, but the present invention is not limited thereto. The present invention can also be applied to any filter for other display devices displaying images.

What is claimed is:

1. A display filter for a display device having a display panel, the display filter comprising:
a base substrate disposed in front of the display panel;
an optical filter part layered based on the base substrate and comprising at least an anti-reflection layer; and
a touch signal sensing part layered on the base substrate or the optical filter part and sensing a touch signal by a sensed object so that the display filter can perform a touch input function.

2. The display filter of claim 1,
wherein the optical filter part further comprising at least one of an electromagnetic wave blocking layer, a near-infrared ray blocking layer, a neon light absorption layer and a color compensation layer layered based on the base substrate.

3. The display filter of claim 1,
wherein the touch signal sensing part comprising:
a first touch sheet in which a first electrode layer is formed on a front surface of the base substrate, and
a second touch sheet disposed such that an air gap is formed between the first touch sheet and the second touch sheet, wherein a second electrode layer is formed on a transparent film and can come into contact with the first electrode layer by an external touch force.

4. The display filter of claim 3,
wherein at least one of the first electrode layer and the second electrode layer comprises a conductive film.

5. The display filter of claim 4,
wherein the conductive film is an ITO film.

6. The display filter of claim 3,
wherein at least one of the first electrode layer and the second electrode layer comprises a conductive mesh pattern.

7. The display filter of claim 6,
wherein the conductive mesh pattern is made of at least one of copper, chrome, nickel, silver, molybdenum, tungsten, and aluminum.

8. The display filter of claim 1,
wherein the touch signal sensing part comprises a transparent electrode layer which is layered in the rear of the base substrate, and transmits electricity due to capacitance at a touched location when the sensed object touches the display filter.

9. The display filter of claim 8,
wherein the touch signal sensing part further comprises a controller which determines the touched location using the electricity transmitted from the transparent electrode layer.

10. The display filter of claim 1,
wherein the optical filter part further comprises an anti-fog layer which is formed on a surface of the display filter facing the display panel to prevent the surface of the display filter from becoming fogged.

11. A display device comprising:
the display filter recited in claim 3, and
the display panel recited in claim 3 which emits a display image through the display filter.

12. A display device comprising:
the display filter recited in claim 8, and
the display panel recited in claim 8 which emits a display image through the display filter.
